(19) United States
(12) Patent Application Publication
(10) Pub. No.: US 2015/0046803 A1
(43) Pub. Date: Feb. 12, 2015

(54) ELECTRONIC DEVICE AND METHOD FOR EDITING DOCUMENT THEREOF

(71) Applicant: Samsung Electronics Co., Ltd., Suwon-si (KR)

(72) Inventors: Yonggil HAN, Gumi-si (KR); Soeun OH, Gumi-si (KR)

(21) Appl. No.: 14/451,949

(22) Filed: Aug. 5, 2014

(30) Foreign Application Priority Data
Aug. 6, 2013 (KR) 10-2013-0092909

(51) Int. Cl. G06F 17/24; G06F 3/041

(52) U.S. Cl. CPC G06F 17/24; G06F 3/041
USPC 715/256

(57) ABSTRACT

A method for editing a document of an electronic device using a touch input is provided. The method includes extracting document position information from document information, sensing the touch input, judging a position of the sensed touch input, determining an attribute of the touch input according to the document position information and the position of the touch input, and changing the document information according to the determined attribute of the touch input.

### CROSS-REFERENCE TO RELATED APPLICATION(S)

This application claims the benefit under 35 U.S.C. §119(a) of a Korean patent application filed on Aug. 6, 2013 in the Korean Intellectual Property Office and assigned Serial number 10-2013-0092909, the entire disclosure of which is hereby incorporated by reference.

### TECHNICAL FIELD

The present disclosure relates to a method for editing a document using a touch input and an electronic device using the same.

### BACKGROUND

The use of touch input to intuitively generate an input in various mobile devices, such as a smart phone and a tablet Personal Computer (PC), has been gradually increased.

The touch input may be generated through an input means, such as a human body (e.g., a finger), a physical tool, or a pen, and demand for intuitive editing of an image or a document through the touch input has recently been increased.

In particular, recently released electronic devices support electronic book (e-book) functions, and users who purchase and use e-book content and users of memo functions capable of storing documents in the electronic devices have been gradually increased. However, according to related-art electronic devices, the utilization of touch inputs is low, and in order to edit a document that includes an e-book or memo, a specific editing menu is entered, which is inconvenient to the user.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure to provide an electronic device and a method for editing a document thereof, which can edit the document through changing of an attribute of a touch input according to a touch position.

In accordance with an aspect of the present disclosure, a method for editing a document of an electronic device using a touch input is provided. The method includes extracting document position information from document information, sensing the touch input, judging a position of the sensed touch input, determining an attribute of the touch input according to the document position information and the position of the touch input, and changing the document information according to the determined attribute of the touch input.

In accordance with another aspect of the present disclosure, an electronic device is provided. The device includes an input unit configured to sense a touch input, a communication unit configured to transmit and receive document information with a specific server or another electronic device, a storage unit configured to store the document information, a display unit configured to display the document information, and a control unit configured to extract document position information from the document information, to judge a position of the sensed touch input, to determine an attribute of the touch input according to the document position information and the position of the touch input, and to change the document information according to the determined attribute of the touch input.

According to the electronic device and the method for editing a document of the electronic device according to the present disclosure, the attribute of the touch input is changed according to the touch position, and thus the user can intuitively edit the document through the touch input.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating the configuration of an electronic device according to an embodiment of the present disclosure;

FIG. 2 is a block diagram illustrating an input unit according to an embodiment of the present disclosure;

FIG. 3 is a flowchart illustrating a method for editing a document of an electronic device according to an embodiment of the present disclosure; and

FIGS. 4A, 4B, 4C, 4D, 4E, and 4F are views explaining a method for editing a document of an electronic device according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

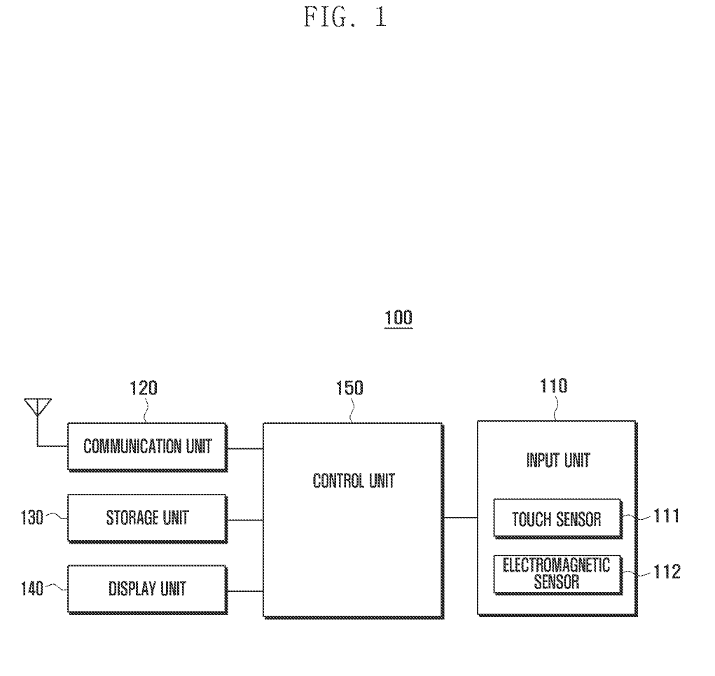

FIG. 1 is a block diagram illustrating the configuration of an electronic device 100 according to an embodiment of the present disclosure.

The electronic device 100 includes an input unit 110, a communication unit 120, a storage unit 130, a display unit 140, and a control unit 150.

The input unit 110 senses a user input and transfers an input signal that corresponds to the user input to the control unit 150. The input unit 110 may include a touch sensor 111 and an electromagnetic sensor 112.

The touch sensor 111 may sense a user's touch input. The touch sensor 111 may be, for example, in the form of a touch film, a touch sheet, a touchpad, or any other similar and/or suitable touch sensor. Additionally or alternatively, the touch sensor 111 may by a pressure sensor implemented by, for example, a pressure pad. The touch sensor 111 senses the touch input and transfers the sensed touch signal to the control unit 150. In this case, information that corresponds to the sensed touch signal may be displayed on the display unit 140. The touch sensor 111 may receive an input of an operation signal by means of the user's touch input through various input means. The touch sensor 111 may sense the touch input through a user's body (e.g., a finger) or a physical tool. According to an implementation method, the touch sensor 111 may sense not only a direct touch but also a proximity input within a predetermined distance.

The electromagnetic sensor 112 may sense a touch or proximity input according to the intensity change of an electromagnetic field. The electromagnetic sensor 112 may include a coil that induces a magnetic field and sense an approach of an object that includes a resonance circuit to cause an energy change of the magnetic field generated by the electromagnetic sensor 112. The electromagnetic sensor 112 may be a pen that includes a stylus pen or a digitizer pen as an object including the resonance circuit. The electromagnetic sensor 112 can sense not only an input that comes in direct contact with the electronic device 100 but also a proximity input or hovering input that is made to approach the electronic device 100. The input means that generates an input for the electromagnetic sensor 112 may include a key, a button, and/or a dial and cause the energy change of the magnetic field differently according to an operation state of the key, the button, and/or the dial. Accordingly, the electromagnetic sensor 112 may sense an operation state of the key, the button, and/or the dial of the input means.

The input unit 110 may include an input pad. The input unit 110 may be configured so that the touch sensor 111 and the electromagnetic sensor 112 are mounted on the input pad. The input unit 110 may be configured so that the touch sensor 111 is attached to the input pad in the form of a film or the touch sensor 111 is combined with the input pad in the form of a panel. Further, the input unit 110 may include an Electro Magnetic Resonance (EMR) or Electro Magnetic Interference (EMI) type input pad using the electromagnetic sensor 112. The input unit 110 may include one or more input pads having a mutual layer structure to sense the input using a plurality of sensors.

The input unit 110 may have a layer structure with the display unit 140 to operate as an input screen. For example, the input unit 110 may include an input pad provided with the touch sensor 111 and may be configured as a Touch Screen Panel (TSP) combined with the display unit 140. Further, the input unit 110 may include an input pad provided with the electromagnetic sensor 112 and may be combined with the display unit 140 having a display panel.

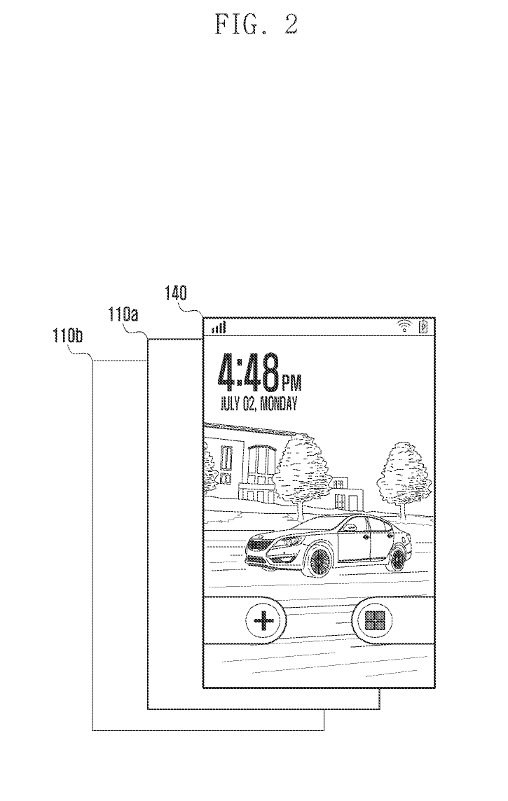

FIG. 2 is a block diagram illustrating the configuration of an input unit 110 according to an embodiment of the present disclosure.

The input unit 110 may include a first input pad 110a and a second input pad 110b that form a mutual layer structure. The first input pad 110a and the second input pad 110b may be a touch pad or a pressure pad having the touch sensor 111, or an electromagnetic pad or an EMR pad having the electromagnetic sensor 112. The first input pad 110a and the second input pad 110b may correspond to different kinds of input means to sense inputs generated by the different kinds of input means. For example, the first input pad 110a may be a touch pad that can sense a touch input by a human body, and the second input pad 110b may be an EMR pad that can sense an input by a pen. The input unit 110 may sense a multi-point input that is generated on the first input pad 110a and the second input pad 110b. In this case, the input pad that senses the input by the pen may sense the operation state of the key, button, or a jog dial provided on the pen.

Further, the input unit 110 may form a layer structure with the display unit 140. The first input pad 110a and the second input pad 110b may be positioned on a lower layer of the display unit 140 to sense inputs generated through an icon, menu, and button displayed on the display unit 140. The display unit 140 may generally have a display panel shape and may be configured as a TSP panel that is combined with the input pad.

The configuration in which the input unit 110 and the display unit 140 are combined as illustrated in FIG. 2 is merely exemplary, and the kind or the number of input pads that form the input unit, and upper and lower layer positions of the input pad and the display unit 140 may be variously changed according to the manufacturing technique of the electronic device 100.

Returning to FIG. 1, the input unit 110 may sense a touch input. The touch input according to an embodiment of the present disclosure may be a hovering input. The input unit 110 may generate an input signal that corresponds to the touch input and transfer the generated input signal to the control unit 150. The input unit 110 may generate the input signal including information on the touch input based on the touch input generation position, the input means, and the operation state of a button provided in the input means.

The communication unit 120 may support a wireless communication function of the electronic device 100 and may be configured as a mobile communication module in a case where the electronic device supports a mobile communication function. For this, the communication unit 120 may include a Radio Frequency (RF) transmission unit that up-converts and amplifies the frequency of a wireless signal being transmitted and an RF reception unit that low-noise-amplifies and down-converts the frequency of the wireless signal being received. Further, in a case where the electronic device 100 supports a short-distance wireless communication function, such as Wi-Fi communication, Bluetooth communication, Zigbee communication, Ultra Wideband (UWB) communication, or Near Field Communication (NFC), the communication unit 120 may include a Wi-Fi communication module, a Bluetooth communication module, a Zigbee communication module, a UWB communication module, or an NFC communication module. In particular, the communication unit 120 according to an embodiment of the present disclosure may transmit/receive document information from a specific server or another electronic device. Here, the document information may be a document file including a document and an image or an electronic book (e-book).

The storage unit 130 may store programs or commands for the electronic device 100. The control unit 150 may execute the programs or command stored in the storage unit 130. The storage unit 130 may include at least one type of storage medium among a flash memory type, a hard disk type, a multimedia card micro type, or a card type memory (e.g., Secure Digital (SD) or xD memory), a Random Access Memory (RAM), a Static Random Access Memory (SRAM), a Read-Only Memory (ROM), an Electrically Erasable Programmable Read-Only Memory (EEPROM), a Programmable Read-Only Memory (PROM), a magnetic memory, a magnetic disc, and an optical disk.

The storage unit 130 stores information on an operation that corresponds to a user input and an input position. For example, the storage unit 130 may store information on an operation that corresponds to an input position where a touch input is generated. The control unit 150 may determine the operation that corresponds to the input position of the touch input based on the information on the operation stored in the storage unit 130 and determine an attribute according to the determined operation. The storage unit 130 may temporarily or permanently store information on document editing attributes including a document underline attribute, a document highlight display attribute, a highlight or underline color change attribute, and a highlight or underline erase attribute. The storage unit 130 may store document information that is received from a specific server or another electronic device through the communication unit 120.

The display unit 140 displays (outputs) information that is processed in the electronic device 100. For example, the display unit 140 may display guide information that corresponds to a currently driven application, program, or service together with a User Interface (UI) or a Graphic User Interface (GUI).

The display unit 140 may include at least one of a Liquid Crystal Display (LCD), a Thin Film Transistor-Liquid Crystal Display (TFT LCD), an Organic Light-Emitting Diode (OLED), a flexible display, and a 3 Dimensional (3D) display.

The display unit 140 may form a mutual layer structure with the touch sensor 111 and/or the electromagnetic sensor 112 constituting the input unit 110 to operate as a touch screen. In this case, the display unit 140 that operates as the touch screen may perform functions of an input device.

Under the control of the control unit 150, the display unit 140 may display document information stored in the storage unit 130. The display unit 140 may display, under the control of the control unit 150, a document editing attribute that corresponds to an input position attribute of the touch input.

The control unit 150 may control respective constituent elements for the entire operation of the electronic device 100. For example, if at least one piece of document information stored in the storage unit 130 is selected by a user, the control unit 150 may operate to display the selected document information on the display unit 140. If the selected document information is displayed on the display unit 140, the control unit 150 may extract document position information, such as a document size or a document position, from the document information. If the touch input is sensed through the input unit 110, the control unit 150 may judge the generation position of the touch input. The control unit 150 may determine the touch input attribute according to the document position information and the touch input position. In other words, the control unit 150 may determine the touch input attribute through judgment of the document position where the touch input is generated from the document position information. The control unit 150 controls the display unit 140 to display an edited document that corresponds to the determined touch input attribute. The touch input attribute may include at least one of a document underline attribute, a document highlight display attribute, a highlight or underline color change attribute, and a highlight or underline erase attribute.

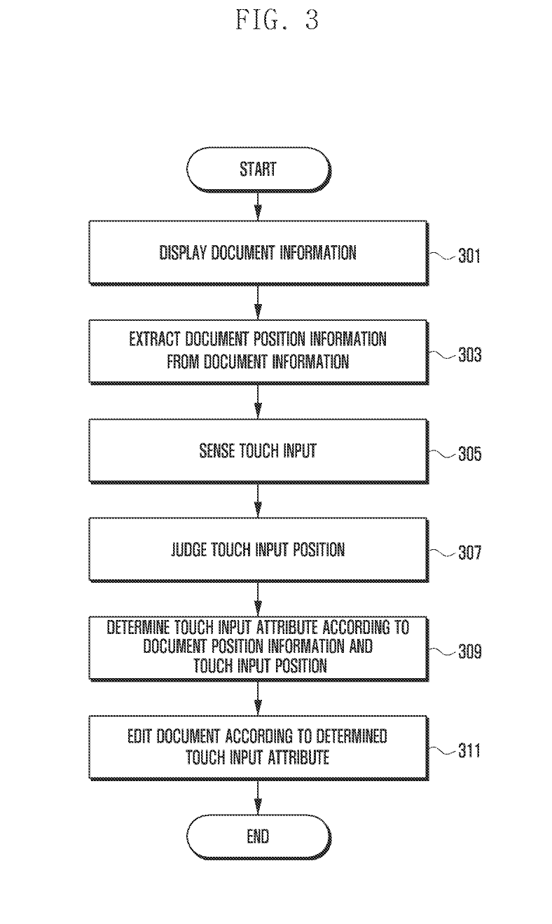

FIG. 3 is a flowchart illustrating a method for editing a document of an electronic device 100 according to an embodiment of the present disclosure.

At operation 301, if at least one piece of document information stored in the storage unit 130 is selected by a user, the electronic device 100 operates to display the selected document information on the display unit 140. At operation 303, if the selected document information is displayed on the display unit 140, the electronic device 100 may extract document position information, such as the size and the position of a document, from the document information. If a touch input is sensed through the input unit 110 at operation 305, the electronic device 100 may judge the generation position of the touch input at operation 307. At operation 309, the electronic device 100 may determine the touch input attribute according to the document position information and the touch input position. At operation 311, the electronic device 100 may edit the document according to the determined touch input attribute and may control the display unit 140 to display the touch input attribute as the document information. Under the control of the control unit 150, the electronic device 100 may store the edited document information in the storage unit 140.

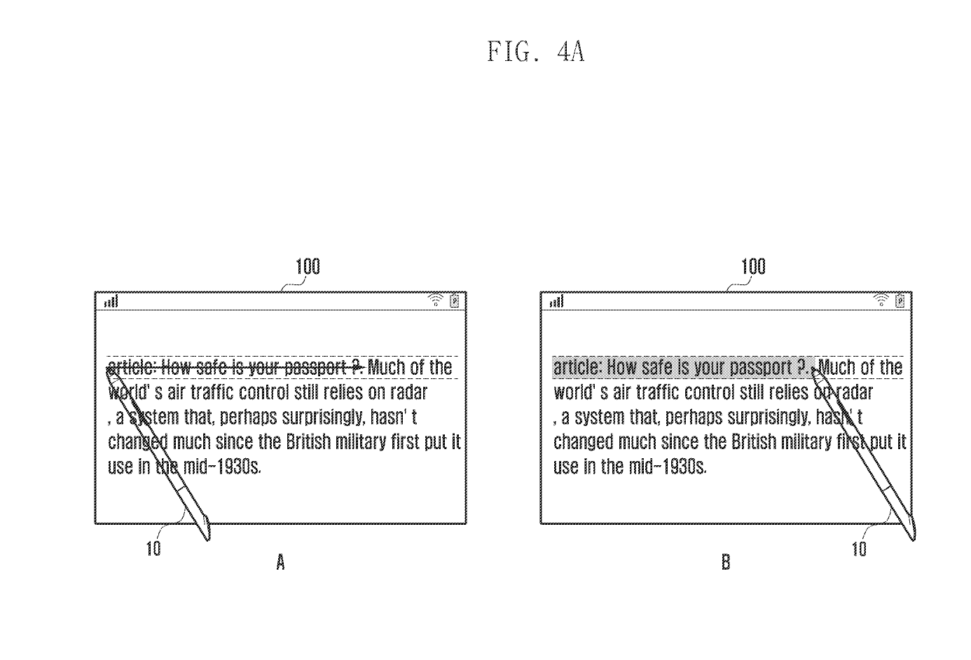

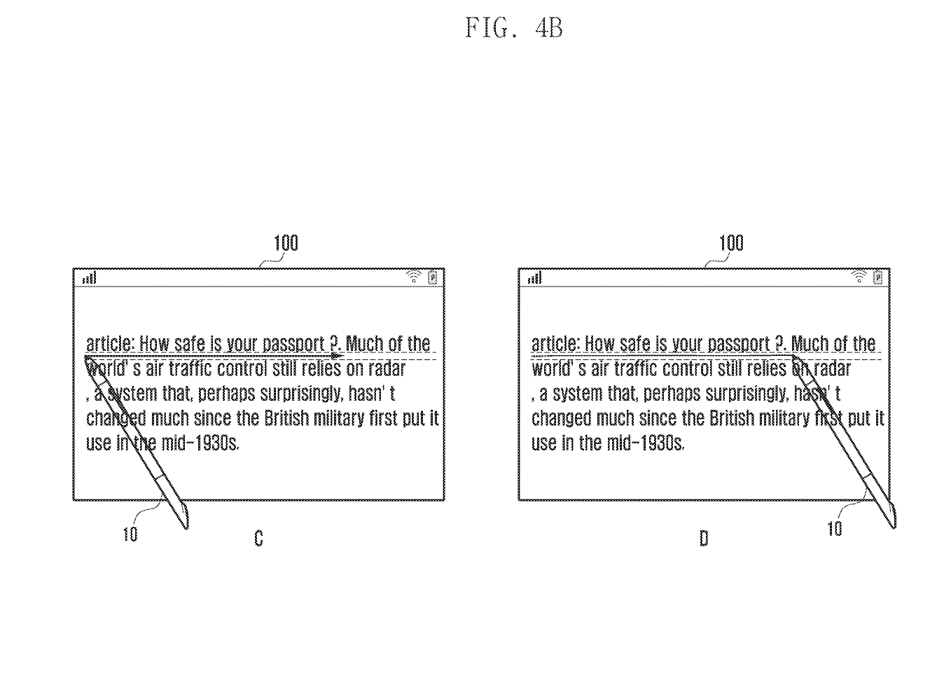

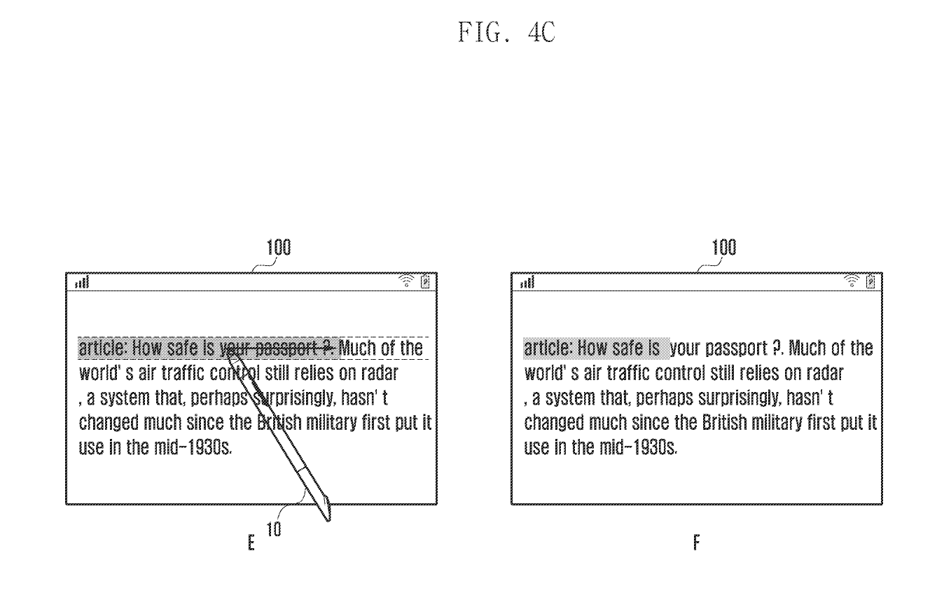

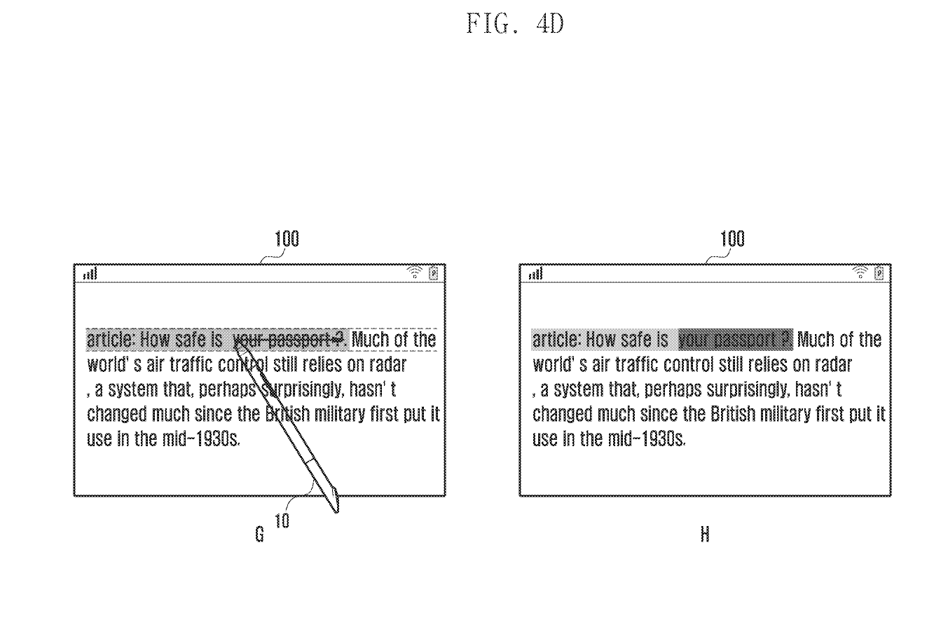

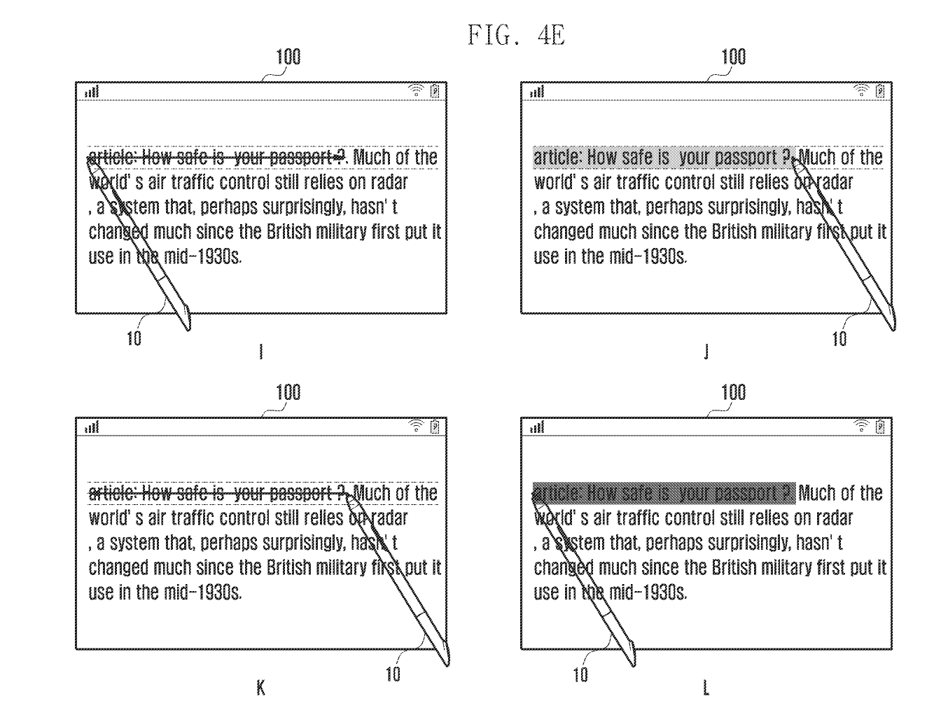

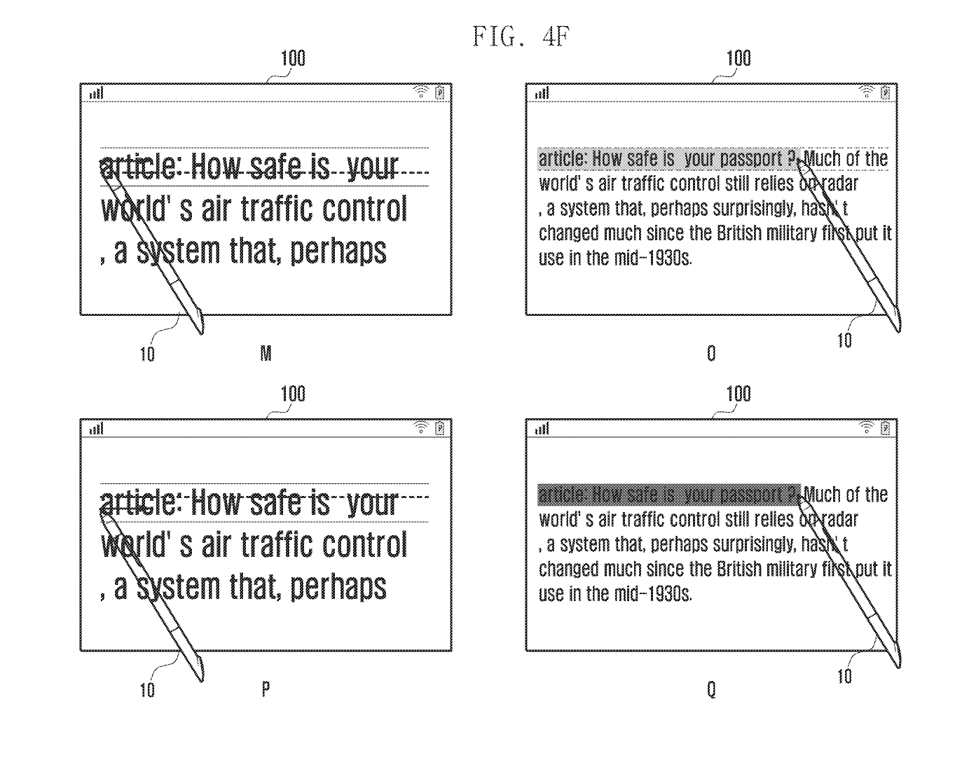

FIGS. 4A to 4F are views explaining a method for editing a document of an electronic device 100 according to an embodiment of the present disclosure.

FIG. 4A is a view explaining a method for editing a document of an electronic device 100 according to an embodiment of the present disclosure. If at least one stored piece of document information is selected by a user as shown in screen A, the electronic device 100 operates to display the selected document information on the display unit 140. If the selected document information is displayed on the display unit 140, the electronic device 100 may extract the document position information, such as the size and the position of a document, from the document information. If a touch input is sensed through the input unit 110 using a stylus pen 10 or a finger, the electronic device 100 may judge the generation position of the touch input.

As shown in screen B, the electronic device 100 may determine the touch input attribute according to the document position information and the touch input position. In other words, the electronic device 100 may determine the touch input attribute through judgment of the document position where the touch input is generated from the document position information. The electronic device 100 controls the display unit 140 to display an edited document that corresponds to the determined touch input attribute. The electronic device 100 may judge the touch input attribute that corresponds to the input position. If a touch input that passes the middle of the document is generated through the stylus pen 10 or the finger on a document line as shown in screens A and B of FIG. 4A, the electronic device 100 may operate to display a highlight display attribute that emphasizes the document. In other words, the electronic device 100 may display the highlight display attribute on the document according to the touch input position that passes the middle of the document among the document position information.

FIG. 4B is a view explaining a method for editing a document of an electronic device 100 according to an embodiment of the present disclosure. If at least one stored piece of document information is selected by a user as shown in screen C, the electronic device 100 operates to display the selected document information on the display unit 140. If the selected document information is displayed on the display unit 140, the electronic device 100 may extract the document position information, such as the size and the position of a document, from the document information. If a touch input is sensed through the input unit 110 using a stylus pen 10 or a finger, the electronic device 100 may judge the generation position of the touch input.

As shown in screen D, the electronic device 100 may determine the touch input attribute according to the document position information and the touch input position. In other words, the electronic device 100 may determine the touch input attribute through judgment of the document position where the touch input is generated from the document position information. The electronic device 100 controls the display unit 140 to display an edited document that corresponds to the determined touch input attribute. The electronic device 100 may judge the touch input attribute that corresponds to the input position. If a touch input that passes the lower end of the document is generated through the stylus pen 10 or the finger on a document line as shown in screens C and D of FIG. 4B, the electronic device 100 may operate to display an underline attribute on the document. In other words, the electronic device 100 may display the highlight display attribute on the document according to the touch input position that passes the lower end of the document among the document position information.

FIG. 4C is a view explaining a method for editing a document of an electronic device 100 according to an embodiment of the present disclosure. If at least one stored piece of document information is selected by a user as shown in screen E, the electronic device 100 operates to display the selected document information on the display unit 140. If the selected document information is displayed on the display unit 140, the electronic device 100 may extract the document position information, such as the size and the position of a document, from the document information. If a touch input is sensed through the input unit 110 using a stylus pen 10 or a finger, the electronic device 100 may judge the generation position of the touch input. As shown in screen E of FIG. 4C, if the touch input that passes the middle of the document is generated using a stylus pen 10 or a finger on a document line, the electronic device 100 displays the highlight display attribute that emphasizes the document.

As shown in screen F, the electronic device 100 may determine the touch input attribute according to the document position information and the touch input position. In other words, the electronic device 100 may determine the touch input attribute through judgment of the document position where the touch input is generated from the document position information. The electronic device 100 controls the display unit 140 to display an edited document that corresponds to the determined touch input attribute. The electronic device 100 may judge the touch input attribute that corresponds to the input position. If a touch input that passes the middle of the document is generated in a state where the highlight display attribute that emphasizes the document is displayed through generation of the touch input that passes the middle of the document using the stylus pen 10 or the finger on a document line as shown in screens E and F of FIG. 4C, the electronic device 100 may operate to display an erase attribute that cancels the highlight already displayed according to the highlight display attribute. If the touch input that passes the lower end of the document is generated again on the displayed portion even in a state where the underline attribute is displayed as shown in screen D, in addition to the highlight display attribute, the erase attribute that cancels the underline already displayed according to the underline attribute may be displayed.

FIG. 4D is a view explaining a method for editing a document of an electronic device 100 according to an embodiment of the present disclosure. If at least one stored piece of document information is selected by a user as shown in screen G, the electronic device 100 operates to display the selected document information on the display unit 140. If the selected document information is displayed on the display unit 140, the electronic device 100 may extract the document position information, such as the size and the position of a document, from the document information. If a touch input is sensed through the input unit 110 using a stylus pen 10 or a finger, the electronic device 100 may judge the generation position of the touch input. As shown in screen G of FIG. 4D, if the touch input that passes the middle of the document is generated using a stylus pen 10 or a finger on a document line, the electronic device 100 displays the highlight display attribute that emphasizes the document.

As shown in screen H, the electronic device 100 may determine the touch input attribute according to the document position information and the touch input position. In other words, the electronic device 100 may determine the touch input attribute through judgment of the document position where the touch input is generated from the document position information. The electronic device 100 controls the display unit 140 to display an edited document that corresponds to the determined touch input attribute. The electronic device 100 may judge the touch input attribute that corresponds to the input position. If a touch input that passes the middle of the document is generated in a state where the highlight display attribute that emphasizes the document is displayed through generation of the touch input that passes the middle of the document using the stylus pen 10 or the finger on a document line as shown in screens G and H of FIG. 4D, the electronic device 100 may operate to display a color change attribute that changes the color of the highlight already displayed according to the highlight display attribute. If the touch input that passes the lower end of the document is generated again on the displayed portion even in a state where the underline attribute is displayed as shown in screen D, in addition to the highlight display attribute, the color change attribute that changes the color of the underline already displayed according to the underline attribute may be displayed.

FIG. 4E is a view explaining a method for editing a document of an electronic device 100 according to an embodiment of the present disclosure. If at least one stored piece of document information is selected by a user as shown in screen I, the electronic device 100 operates to display the selected document information on the display unit 140. If the selected document information is displayed on the display unit 140, the electronic device 100 may extract the document position information, such as the size and the position of a document, from the document information. If a touch input is sensed through the input unit 110 using a stylus pen 10 or a finger, the electronic device 100 may judge the generation position of the touch input.

As shown in screen J, the electronic device 100 may determine the touch input attribute according to the document position information and the touch input position. In other words, the electronic device 100 may determine the touch input attribute through judgment of the document position where the touch input is generated from the document position information. The electronic device 100 controls the display unit 140 to display an edited document that corresponds to the determined touch input attribute. The electronic device 100 may judge the touch input attribute that corresponds to the input position. If a touch input that passes the middle of the document is generated in a first direction (e.g., from left to right) using the stylus pen 10 or the finger on a document line as shown in screens I and J of FIG. 4E, the electronic device 100 may operate to display a highlight display attribute including a first color that emphasizes the document. In other words, the electronic device 100 may display the highlight display attribute including the first color on the document according to the touch input position that passes the middle of the document among the document position information.

If at least one stored piece of document information is selected by a user as shown in screen K, the electronic device 100 operates to display the selected document information on the display unit 140. If the selected document information is displayed on the display unit 140, the electronic device 100 may extract the document position information, such as the size and the position of a document, from the document information. If a touch input is sensed through the input unit 110 using a stylus pen 10 or a finger, the electronic device 100 may judge the generation position of the touch input.

As shown in screen L, the electronic device 100 may determine the touch input attribute according to the document position information and the touch input position. In other words, the electronic device 100 may determine the touch input attribute through judgment of the document position where the touch input is generated from the document position information. The electronic device 100 controls the display unit 140 to display an edited document that corresponds to the determined touch input attribute. The electronic device 100 may judge the touch input attribute that corresponds to the input position. If a touch input that passes the middle of the document is generated in a second direction (e.g., from right to left) using the stylus pen 10 or the finger on a document line as shown in screens K and L of FIG. 4E, the electronic device 100 may operate to display a highlight display attribute including a second color that emphasizes the document. In other words, the electronic device 100 may display the highlight display attribute including the second color on the document according to the touch input position that passes the middle of the document among the document position information.

FIG. 4F is a view explaining a method for editing a document of an electronic device 100 according to an embodiment of the present disclosure. If at least one stored piece of document information is selected by a user as shown in screen M, the electronic device 100 operates to display the selected document information on the display unit 140. If the selected document information is displayed on the display unit 140, the electronic device 100 may extract the document position information, such as the size and the position of a document, from the document information. If a touch input is sensed through the input unit 110 using a stylus pen 10 or a finger, the electronic device 100 may judge the generation position of the touch input.

As shown in screen O, the electronic device 100 may determine the touch input attribute according to the document position information and the touch input position. In other words, the electronic device 100 may determine the touch input attribute through judgment of the document position where the touch input is generated from the document position information. The electronic device 100 controls the display unit 140 to display an edited document that corresponds to the determined touch input attribute. The electronic device 100 may judge the touch input attribute that corresponds to the input position. If a touch input that passes the upper end than the middle of the document is generated using the stylus pen 10 or the finger on a document line as shown in screens M and O of FIG. 4F, the electronic device 100 may operate to display a highlight display attribute including a first color that emphasizes the document. However, when the touch input passes the upper end than the middle of the document, it does not get out of the document. In other words, the electronic device 100 may display the highlight display attribute including the first color on the document according to the touch input position that passes the middle of the document among the document position information.

If at least one stored piece of document information is selected by a user as shown in screen P, the electronic device 100 operates to display the selected document information on the display unit 140. If the selected document information is displayed on the display unit 140, the electronic device 100 may extract the document position information, such as the size and the position of a document, from the document information. If a touch input is sensed through the input unit 110 using a stylus pen 10 or a finger, the electronic device 100 may judge the generation position of the touch input.

As shown in screen Q, the electronic device 100 may determine the touch input attribute according to the document position information and the touch input position. In other words, the electronic device 100 may determine the touch input attribute through judgment of the document position where the touch input is generated from the document position information. The electronic device 100 controls the display unit 140 to display an edited document that corresponds to the determined touch input attribute. The electronic device 100 may judge the touch input attribute that corresponds to the input position. If a touch input that passes the lower end than the middle of the document is generated using the stylus pen 10 or the finger on a document line as shown in screens P and Q of FIG. 4F, the electronic device 100 may operate to display a highlight display attribute including a second color that emphasizes the document. However, when the touch input passes the lower end than the middle of the document, it does not get out of the document. In other words, the electronic device 100 may display the highlight display attribute including the second color on the document according to the touch input position that passes the middle of the document among the document position information.

As described above, embodiments of the present disclosure may be provided in a form of program commands executable through various computer means and recorded in a non-transitory recording media readable by a computer. Here, the non-transitory recording media readable by a computer may include a program command, data file, data structure, and any combination thereof. In the meantime, the program command recorded in the non-transitory recording media may be one specially designed for the embodiments of the present disclosure or one disclosed in the art of computer software. The non-transitory recording media readable by a computer may include hardware devices specially designed to store and execute programs such as magnetic media (hard disk, floppy disk, and magnetic tape), optical media (Compact Disc-Read Only Memory (CD-ROM) and Digital Versatile Disc (DVD)), magneto-optical media (floptical disk), Read Only Memory (ROM), Random Access Memory (RAM), and flash memory. Further, the program command may include a high level language code executable by a computer having an interpreter as well as a machine language code provided by a complier. The hardware device may be configured with at least one software module to perform operations according to various embodiments of the present disclosure.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for editing a document of an electronic device using a touch input, the method comprising:
extracting document position information from document information;
sensing the touch input;
judging a position of the sensed touch input;
determining an attribute of the touch input according to the document position information and the position of the touch input; and
changing the document information according to the determined attribute of the touch input.

2. The method of claim 1, wherein the attribute of the touch input includes at least one of an underline attribute, a highlight display attribute, a highlight color change attribute, an underline color change attribute, a highlight erase attribute, and an underline erase attribute.

3. The method of claim 2, wherein the determining of the attribute of the touch input comprises determining the attribute of the touch input as the highlight display attribute that includes a first color if the touch input is sensed that crosses a center of the document in a first direction according to the document position information and the position of the touch input.

4. The method of claim 3, wherein the determining of the attribute of the touch input comprises determining the attribute of the touch input as the highlight erase attribute if the touch input is sensed that crosses the document information displayed as the highlight display attribute in the first direction.

5. The method of claim 3, wherein the determining of the attribute of the touch input comprises determining the attribute of the touch input as the highlight display attribute that includes a second color if the touch input is sensed that crosses the document information displayed as the highlight display attribute including the first color in the first direction.

6. The method of claim 2, wherein the determining of the attribute of the touch input comprises determining the attribute of the touch input as the highlight display attribute that includes a first color if the touch input is sensed that crosses above a center of the document within a document range in a first direction according to the document position information and the position of the touch input.

7. The method of claim 6, wherein the determining of the attribute of the touch input comprises determining the attribute of the touch input as the highlight display attribute that includes a second color if the touch input is sensed that crosses lower than the center of the document within a document range in a first direction according to the document position information and the position of the touch input.

8. The method of claim 2, wherein the determining of the attribute of the touch input comprises determining the attribute of the touch input as the underline attribute that includes a first color if the touch input is sensed that crosses a lower end of the document in a first direction according to the document position information and the position of the touch input.

9. The method of claim 8, wherein the determining of the attribute of the touch input comprises determining the attribute of the touch input as the underline erase attribute if the touch input is sensed that crosses the document information displayed as the underline attribute in the first direction.

10. The method of claim 8, wherein the determining of the attribute of the touch input comprises determining the attribute of the touch input as the underline attribute that includes a second color if the touch input is sensed that crosses the document information displayed as the underline attribute including the first color in the first direction.

11. The method of claim 1, wherein the document position information includes at least one of size and position of the document.

12. At least one non-transitory processor readable medium storing a computer program of instructions configured to be readable by at least one processor for instructing the at least one processor to execute a computer process for performing the method of claim 1.

13. An electronic device comprising:
an input unit configured to sense a touch input;
a communication unit configured to transmit and receive document information with a specific server or another electronic device;
a storage unit configured to store the document information;
a display unit configured to display the document information; and
a control unit configured to extract document position information from the document information, to judge a position of the sensed touch input, to determine an attribute of the touch input according to the document position information and the position of the touch input, and to change the document information according to the determined attribute of the touch input.

14. The electronic device of claim 13, wherein the attribute of the touch input includes at least one of an underline attribute, a highlight display attribute, a highlight color change attribute, an underline color change attribute, a highlight erase attribute, and an underline erase attribute.

15. The electronic device of claim 14, wherein the control unit determines the attribute of the touch input as the highlight display attribute that includes a first color if the touch input is sensed that crosses a center of the document in a first direction according to the document position information and the position of the touch input.

16. The electronic device of claim 15, wherein the control unit determines the attribute of the touch input as the highlight erase attribute if the touch input is sensed that crosses the document information displayed as the highlight display attribute in the first direction.

17. The electronic device of claim 15, wherein the control unit determines the attribute of the touch input as the highlight display attribute that includes a second color if the touch input is sensed that crosses the document information displayed as the highlight display attribute including the first color in the first direction.

18. The electronic device of claim 14, wherein the control unit determines the attribute of the touch input as the highlight display attribute that includes a first color if the touch input is sensed that crosses above a center of the document within a document range in a first direction according to the document position information and the position of the touch input.

19. The electronic device of claim 18, wherein the control unit determines the attribute of the touch input as the highlight display attribute that includes a second color if the touch input is sensed that crosses lower than the center of the document within a document range in a first direction according to the document position information and the position of the touch input.

20. The electronic device of claim 14, wherein the determining of the attribute of the touch input comprises determining the attribute of the touch input as the underline attribute that includes a first color if the touch input is sensed that crosses a lower end of the document in a first direction according to the document position information and the position of the touch input.

21. The electronic device of claim 20, wherein the control unit determines the attribute of the touch input as the underline erase attribute if the touch input is sensed that crosses the document information displayed as the underline attribute in the first direction.

22. The electronic device of claim 20, wherein the control unit determines the attribute of the touch input as the underline attribute that includes a second color if the touch input is sensed that crosses the document information displayed as the underline attribute including the first color in the first direction.

23. The electronic device of claim 13, wherein the document position information includes at least one of size and position of the document.
